(19) United States
(12) Patent Application Publication
(10) Pub. No.: US 2024/0285990 A1
(43) Pub. Date: Aug. 29, 2024

(54) ORGANIC-INORGANIC HYBRID TYPE FIRE-EXTINGUISHING MICROCAPSULE HAVING DOUBLE-WALL STRUCTURE, METHOD FOR MANUFACTURING SAME, AND FIRE-EXTINGUISHING COMPOSITION COMPRISING SAME

(71) Applicant: KONKUK UNIVERSITY INDUSTRIAL COOPERATION CORP., Seoul (KR)

(72) Inventors: Ji Bong JOO, Seoul (KR); Dong Hun LEE, Seoul (KR); Na Yeon KIM, Chuncheon-si (KR); Yoon Hee KIM, Seoul (KR); Ji Yul KIM, Seoul (KR); Hyun Sung JANG, Yongin-si (KR); Dong Seop CHOI, Goyang-si (KR)

(73) Assignee: KONKUK UNIVERSITY INDUSTRIAL COOPERATION CORP., Seoul (KR)

(21) Appl. No.: 18/601,213

(22) Filed: Mar. 11, 2024

Related U.S. Application Data
(63) Continuation of application No. PCT/KR2022/013915, filed on Sep. 16, 2022.

(30) Foreign Application Priority Data
Sep. 16, 2021 (KR) 10-2021-0124122

(51) Int. Cl. A62D 1/00; B01J 13/14

(52) U.S. Cl. CPC A62D 1/0021; B01J 13/14

(57) ABSTRACT

The present invention relates to a fire-extinguishing microcapsule, a method for manufacturing same, and a fire-extinguishing composition comprising same. The microcapsule includes a core containing a non-inflammable material; a first shell layer covering the core and containing inorganic nanoparticles and a water-soluble polymer; and a second shell layer covering the first shell layer and containing a polymer.

### CROSS-REFERENCE TO RELATED APPLICATIONS

This application is a continuation of International Application No. PCT/KR2022/013915 filed on Sep. 16, 2021, which claims priority to Korean Patent Application No. 10-2021-0124122 filed on Sep. 16, 2021, the entire contents of which are herein incorporated by reference.

### TECHNICAL FIELD

The present disclosure relates to a fire-extinguishing microcapsule for fire suppression, a method of preparing the same, and a fire-extinguishing composition containing the same.

### BACKGROUND ART

Microencapsulation is a technology in which liquid or solid substances inside are surrounded by organic or inorganic materials to prepare a type of capsule, which is used to selectively release substances inside or to protect internal substances from external environmental stimuli, such as humidity, pressure, temperature, and the like. Representative examples of microencapsulation technology include the coacervation method, interfacial polymerization method, and in-situ method, each of which is selected in consideration of the physical and chemical properties of internal substances or interaction with the outer wall materials.

Microcapsules have various advantages of protecting sensitive substances from deterioration processes, acting as a means of release by which active materials are controlled, and the like, and thus are used as a base technology in various fields of pharmaceuticals, cosmetics, paints, printed electronics, firefighting technology, and the like. In particular, regarding firefighting technology, fire-extinguishing compositions for fire suppression using microcapsules including an outer wall made of polymers, such as gelatin, and a fire-extinguishing agent as a core material are well known.

However, the outer wall based on polymers, such as gelatin, of fire-extinguishing microcapsules, according to existing technologies, has disadvantages in that the mechanical strength is poor compared to that of microcapsules having an outer wall based on inorganic materials, the loss of internal substances is significant, and the thermal conductivity is poor. Such low thermal conductivity functions as a factor that delays heat transfer occurring in the event of a fire and hinders the rapid fire-extinguishing process, which thus must be improved. Additionally, low mechanical stability necessitates additional support materials, such as polymeric sheets, so there is a disadvantage in that the existing microcapsules cannot be used alone. Furthermore, considering that the ignition point and temperature are not always the same in places where an actual fire occurs, traditional operation allowing internal substances to be released at a constant temperature has difficulty in preventing fire in various environments.

### DISCLOSURE

### Technical Problem

The present disclosure, which has been made to solve the problems in the related art as described above, aims to provide a fire-extinguishing microcapsule that not only has improved mechanical stability compared to fire-extinguishing microcapsules in the related art but also is capable of adjusting the operating temperature range in the event of a fire, a method of preparing the same, and a fire-extinguishing composition containing the same.

### Technical Solution

To solve the above technical problems, in the present disclosure, proposed is a fire-extinguishing microcapsule including a core containing a non-flammable material, a first shell layer covering the core and containing inorganic nanoparticles and a water-soluble polymer, and a second shell layer covering the first shell layer and containing a polymer.

FIG. 1 is a schematic cross-sectional view of one example of a fire-extinguishing microcapsule according to the present disclosure. The fire-extinguishing microcapsule may be composed of a core made of a liquid non-flammable material, a first shell layer formed on the core and serving as a polymer-based organic-inorganic composite outer wall containing inorganic nanoparticles, and a second shell layer formed on the first shell layer and serving as a polymer-based outer wall.

Examples of the non-flammable material constituting the core may include methoxynonafluorobutane, dibromomethane, methoxyheptafluoropropane, and the like, but are not limited thereto.

The first shell layer covering a part or all of the surface of the core is preferably an organic-inorganic hybrid outer wall having a structure in which the inorganic nanoparticles made of titanium dioxide (TiO₂), silica (SiO₂), alumina (Al₂O₃), and the like are dispersed in a water-soluble polymer matrix. In this case, an acrylic group may be introduced into the surface of the inorganic nanoparticles.

The water-soluble polymer constituting the polymer matrix of the first shell layer may be any one or a mixture of two or more selected from the group consisting of gelatin, chitosan, chitin, pectin, locust bean gum, gellan gum, alginic acid, agar, carrageenan, collagen, hyaluronic acid, guar gum, ethylcellulose, methylcellulose, carboxymethylcellulose, and polyacrylic acid, but is not necessarily limited thereto.

On the other hand, the polymer-based second shell layer covering a part or all of the first shell layer may be made of a urea-formaldehyde resin or a resorcinol-formaldehyde resin, but is not necessarily limited thereto.

Additionally, in another aspect of the present disclosure, proposed is a method of preparing the fire-extinguishing microcapsule, which includes (a) preparing an emulsion including a non-flammable material, inorganic nanoparticles, and a water-soluble polymer, (b) preparing a microcapsule including a core containing the non-flammable material and a first shell layer containing the inorganic nanoparticles and the water-soluble polymer by adding a pH adjuster to the emulsion for pH adjustment of the emulsion, adding a cross-linking agent, and stirring the resulting product, and (c) forming a second shell layer containing a polymer on the first shell layer of the microcapsule.

In (a), the emulsion containing the inorganic nanoparticles and the water-soluble polymer in the first shell layer as well as the non-flammable material in the core is prepared.

Then, in (b), the pH of the emulsion is adjusted by adding the pH adjuster, such as an acetic acid aqueous solution, to the emulsion prepared in (a). Next, the cross-linking agent selected from among glutaraldehyde, formaldehyde, transglutaminase, tannic acid, alum, and the like is added, and the resulting product is then stirred to induce a reaction, thereby preparing the microcapsule including the core and the first shell layer.

Subsequently, in (c), polymer precursors to form the second shell layer, a dispersion stabilizer, and an acid catalyst such as hydrochloric acid are mixed with the solution in which the microcapsule having the structure of the core/first shell layer prepared in (b) is dispersed, followed by inducing the reaction, to form the second shell layer covering a part or all of the first shell layer.

In this case, the polymer precursors may be selected according to the polymer constituting the second shell layer. For example, the polymer precursors to form the second shell layer made of a urea-formaldehyde resin may be urea and formaldehyde, and the polymer precursors to form the second shell layer made of a resorcinol-formaldehyde resin may be resorcinol and formaldehyde.

Additionally, the dispersion stabilizer may be polyvinyl pyrrolidone or cetrimonium bromide, but is not necessarily limited thereto.

Furthermore, in a further aspect of the present disclosure, proposed is a fire-extinguishing composition including the fire-extinguishing microcapsule and a binder.

In this case, the binder may be any one or a mixture of two or more selected from the group consisting of silicone rubber, nitrocellulose, polypropylene, polyethylene, polystyrene, polyvinyl chloride, polyurethane, polyamide, a melamine resin, an isocyanate resin, phenol formaldehyde, urea formaldehyde, and melamine formaldehyde, but is not necessarily limited thereto.

### Advantageous Effects

In a fire-extinguishing microcapsule according to the present disclosure, an outer wall (first shell) made of an organic polymer and an inorganic material, the outer wall surrounding a liquid non-flammable fire-extinguishing agent serving as a core for encapsulation, is not only stronger than an outer wall made of a polymer alone but also has high thermal conductivity, and thus can rapidly react to external temperature rise. Additionally, the first shell can adjust the operating temperature range of the fire-extinguishing microcapsule by containing various inorganic materials that differ in thermal conductivity.

### DESCRIPTION OF DRAWINGS

FIG. 1 is a cross-sectional view of an organic-inorganic composite capsule having a double-wall structure for fire suppression according to the present disclosure;

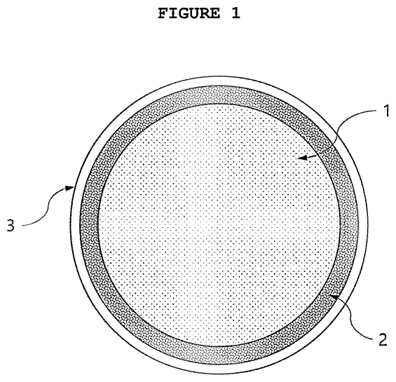

FIG. 2 is a digital camera image of an organic-inorganic composite capsule for fire suppression according to one example of the present disclosure;

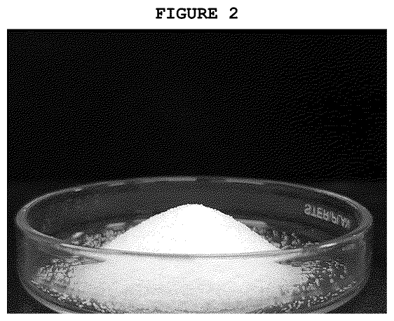

FIG. 3 is a field emission scanning electron microscope (FESEM) image of an organic-inorganic composite capsule for fire suppression according to one example of the present disclosure;

FIG. 4 is a graph showing thermogravimetric analysis results of organic-inorganic composite capsules for fire suppression operable at varying temperatures according to examples of the present disclosure;

FIG. 5 is a graph showing X-ray fluorescence (XRF) analysis results of an organic-inorganic composite capsule for fire suppression according to one example of the present disclosure;

FIG. 6 is a graph showing mass loss when stored at room temperature according to examples of the present disclosure;

FIG. 7 shows images of results obtained when performing fire extinguishment according to one example of the present disclosure; and

FIGS. 8A through 8C show energy-dispersive spectroscopy (EDS) mapping images of the polymer matrix of each outer wall of microcapsules in which inorganic materials that differ from each other are dispersed according to examples of the present disclosure.

### MODE FOR INVENTION

In describing the present disclosure, if it is determined that a detailed description of a related known function or configuration may unnecessarily obscure the gist of the present disclosure, the detailed description will be omitted.

Embodiments according to the concept of the present disclosure can be applied to various changes and can have various forms, so specific embodiments are illustrated in the drawings and described in detail in this specification or application. However, this is not intended to limit the embodiments according to the concept of the present disclosure to a specific disclosed form and should be understood to include all changes, equivalents, or substitutes included in the spirit and technical scope of the present disclosure.

Terms used herein are only used to describe specific embodiments and are not intended to limit the present disclosure. As used herein, the singular forms “a”, “an”, and “the” are intended to include the plural forms as well unless the context clearly indicates otherwise. Terms such as “comprise” or “have” used herein are intended to designate that the described feature, number, step, operation, component, part, or combination thereof exists, but one or more other features or numbers However, it should be understood that it does not preclude the presence or addition of steps, operations, components, parts, or combinations thereof.

Hereinafter, the present disclosure will be described in more detail through examples.

The embodiments according to the present specification may be modified in many different forms, and the scope of the present specification is not construed as being limited to the embodiments described below. The embodiments of the present disclosure described hereinbelow are provided to allow those skilled in the art to more clearly comprehend the present disclosure.

### Example

Like in the related art, an outer wall based on polymers, such as gelatin, has disadvantages in that the mechanical strength is poor compared to that of microcapsules having an outer wall based on inorganic materials, the loss of internal substances is significant, and the thermal conductivity is poor. Low thermal conductivity functions as a factor that delays heat transfer occurring in the event of a fire and hinders the rapid fire-extinguishing process, which thus must be improved. Additionally, low mechanical stability necessitates additional support materials, such as polymeric sheets, so there is a disadvantage in that the existing microcapsules cannot be used alone. Furthermore, considering that the ignition point and temperature are not always the same in places where an actual fire occurs, traditional operation allowing internal substances to be released at a constant temperature has difficulty in preventing fire in various environments.

In the present disclosure, to solve these problems, capsules are prepared by adding inorganic nanomaterials that differ in thermal conductivity. The inorganic nanomaterial contains 0.1 to 10 wt % of a halogen-based flame retardant as internal substances, and a level of the size thereof ranges from tens of nanometers to several micrometers. A process of preparing the composite capsule is divided into the following steps: preparing a water-soluble solution based on a polymer, such as stable gelatin, containing inorganic materials; forming an organic-inorganic composite shell by electrostatic attraction between polymers through pH adjustment; forming a secondary wall using polymers and copolymers; and lastly filtering and drying the resulting composite capsule.

### Example 1: Preparation of Gelatin-Titanium Dioxide-Hexametaphosphate Microcapsules

To 100 ml of anhydrous ethanol, 2.0 to 20 g of titanium dioxide powder was added. Then, the resulting product was sonicated for 1 hour for dispersion. Next, 0.3 g of trimethoxylpropylmethacrylate (hereinafter referred to as A174) was added to 20 ml of anhydrous ethanol and heated to the temperature of 40° C. to 50° C. for stirring. The prepared solution of A174 was added to the highly dispersed suspension of titanium dioxide particles, heated to the temperature of 70° C. to 80° C., and then stirred for 3 hours. Through centrifugation and washing, a partially hydrophobic inorganic material to be used in preparing microcapsules was prepared.

Depending on the purpose of use, 0.02 to 2.0 g of the prepared inorganic material was dispersed in 100 mL of distilled water. Then, 4.5 g of gelatin treated with base was added to the titanium dioxide suspension and heated to the temperature of 50° C. to 60° C., thereby obtaining a homogeneous suspension. Next, 15 mL of a halogen-based non-flammable material (methoxynonafluorobutane) was added to the obtained suspension and then stirred at a rate of 500 to 800 rpm, thereby obtaining an emulsion. After slowly adding 50 mL of 0.6 wt % of an aqueous hexametaphosphate solution to the emulsion solution and stirring the resulting solution for 10 minutes, the pH was reduced to 4.6 to 4.7 using a 10% acetic acid solution. Afterward, the temperature was reduced to 5° C. using a cooling circulating water bath to cool this solution, and 2.5 mL of 50 wt % of glutaric aldehyde was then slowly added at a rate of 0.05 mL per minute with stirring. After raising the temperature to 35° C., 0.2 g of polyvinylpyrrolidone was added, followed by stirring the resulting product for 10 minutes. Next, after adding 1 g of urea and 2.44 g of a formaldehyde solution, a 35% to 37% hydrochloric acid solution was added to adjust the pH to 1.5 to 2.0, and then a reaction occurred for 3 hours. The resulting suspension was filtered and dried at room temperature, thereby obtaining microcapsule powder.

### Example 2: Preparation of Gelatin-Silica-Hexametaphosphate Microcapsules

To 150 ml of a solution in which distilled water and anhydrous ethanol were mixed in a ratio of 1:1, 0.1 to 10 g of silica powder was added. Then, the resulting product was sonicated for 1 hour for dispersion. Next, 0.5 g of trimethoxylpropylmethacrylate (hereinafter referred to as A174) was added to the 50 ml of the solution in which distilled water and anhydrous ethanol were mixed in a ratio of 1:1 and heated to the temperature of 40° C. to 50° C. for stirring. The prepared solution of A174 was added to the highly dispersed suspension of dry silica particles, heated to the temperature of 70° C. to 80° C., and then stirred for 3 hours. Through centrifugation and washing, a partially hydrophobic inorganic material to be used in preparing microcapsules was prepared.

Depending on the purpose of use, 0.02 to 2.0 g of the prepared inorganic material was dispersed in 100 mL of distilled water. Then, 4.5 g of gelatin treated with base was added to the silica suspension and heated to the temperature of 50° C. to 60° C., thereby obtaining a homogeneous suspension. Next, 15 mL of a halogen-based non-flammable material (methoxynonafluorobutane) was added to the obtained suspension and then stirred at a rate of 500 to 8000 rpm, thereby obtaining an emulsion. After slowly adding 50 mL of 0.6 wt % of an aqueous hexametaphosphate solution to the emulsion solution and stirring the resulting solution for 10 minutes, the pH was reduced to 4.3 using a 10% acetic acid solution. Afterward, the temperature was reduced to 5° C. using a cooling circulating water bath to cool this solution, and 5 mL of 25 wt % glutaric aldehyde was then slowly added at a rate of 0.1 mL per minute with stirring. After raising the temperature to 40° C., 0.1 g of cetrimonium bromide was added, followed by stirring the resulting product for 10 minutes. Next, after adding 0.5 g of resorcinol and 2.44 g of a formaldehyde solution, a 35% to 37% hydrochloric acid solution was added to adjust the pH to 1.5 to 2.0, and then a reaction occurred for 3 hours. The resulting suspension was filtered and dried at room temperature, thereby obtaining microcapsule powder.

### Example 3: Preparation of Gelatin-Alumina-Hexametaphosphate Microcapsules

In 100 mL of distilled water, 0.02 to 2.0 g of hydrophilic alumina powder was dispersed. Then, 4.5 g of gelatin treated with base was added to a silica suspension and heated to the temperature of 50° C. to 60° C., thereby obtaining a homogeneous suspension. Next, mL of a halogen-based non-flammable material (methoxynonafluorobutane) was added to the obtained suspension and then stirred at a rate of 500 to 8000 rpm, thereby obtaining an emulsion. After injecting 50 mL of 0.6 wt % of an aqueous hexametaphosphate solution into the emulsion solution at a rate of 5 mL per minute and stirring the resulting solution for 10 minutes, the pH was reduced to 4.3 using a 0.1 M acetic acid solution. Afterward, the temperature was reduced to 5° C. using a cooling circulating water bath to cool this solution, and 5 mL of 25 wt % of glutaric aldehyde was then slowly added at a rate of 0.1 mL per minute with stirring. After raising the temperature to 40° C., 0.5 g of polyvinylpyrrolidone was added, and then the resulting product was stirred for 10 minutes. Next, after adding 1.875 g of urea and 4.16 mL of a formaldehyde solution, a 1.0 M hydrochloric acid solution was added to adjust the pH to 1.5 to 2.0, and then a reaction occurred for 3 hours. The resulting suspension was filtered and dried at room temperature, thereby obtaining microcapsule powder.

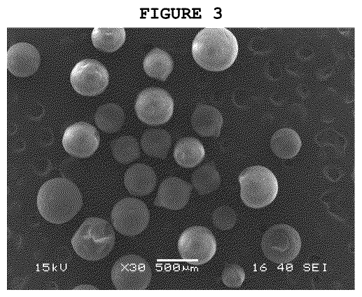

FIG. 3 is a scanning electron microscope (SEM) image of the microcapsule prepared in Example 1 herein.

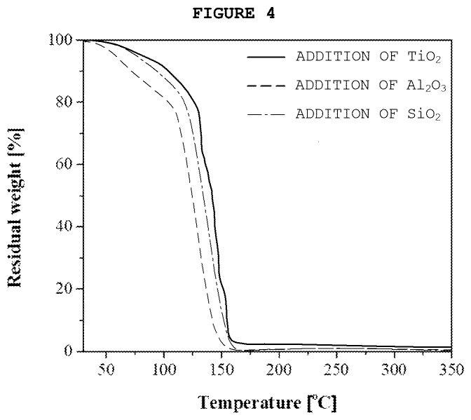

FIG. 4 shows thermogravimetric analysis results of the microcapsules each independently prepared in Examples 1 to 3 herein, demonstrating that the microcapsules of examples herein are operable at varying temperatures depending on the types of inorganic materials contained in the microcapsules according to examples herein.

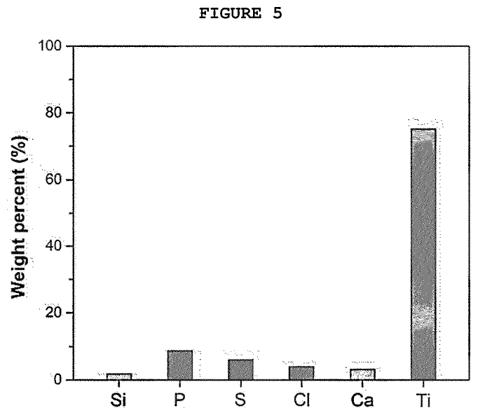

FIG. 5 shows X-ray fluorescence (XRF) analysis results of the outer wall of the microcapsule prepared in Example 1 herein.

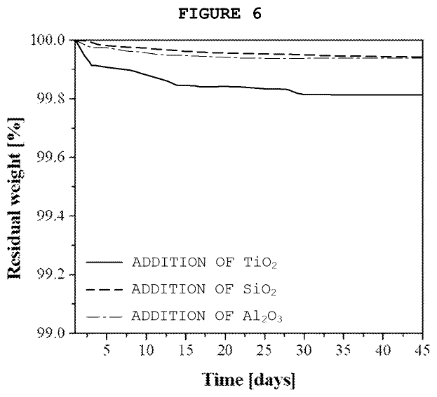

FIG. 6 shows results of changes in the weight of the microcapsules each independently prepared in Examples 1 to 3 herein for 45 days.

These results demonstrate the stability of the outer wall of the microcapsule and show that the internal substance is kept from being lost even after long-term storage.

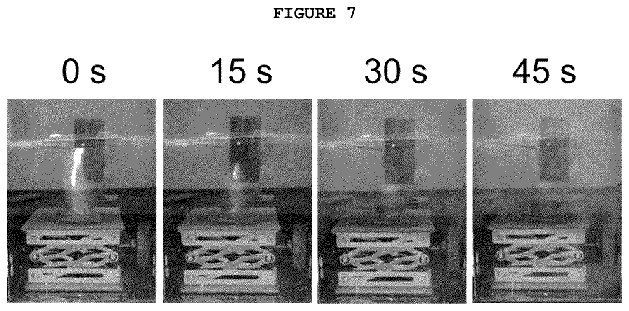

FIG. 7 shows results of laboratory-scale fire suppression experiments performed on the microcapsule prepared in Example 1 herein.

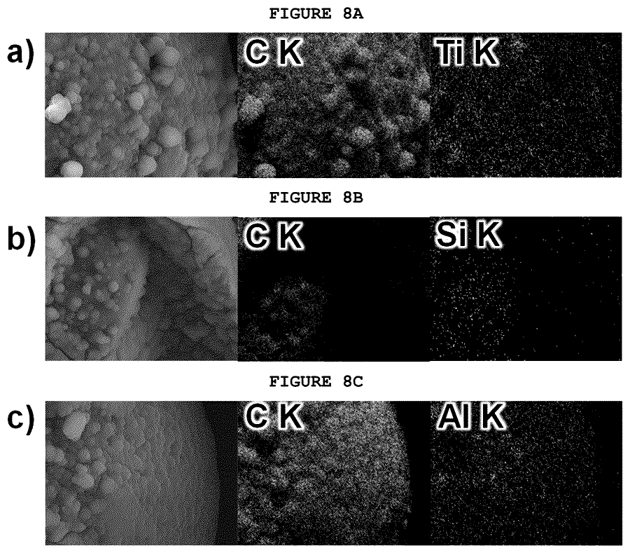

FIGS. 8A to 8C show energy-dispersive spectroscopy (EDS) mapping images of the outer walls of the microcapsules each independently prepared in Examples 1 to 3 herein.

The left images are SEM images of each polymer matrix of the outer wall of the capsules, and the middle images show each polymer matrix through the positions of carbon atoms. The right images show that the inorganic (TiO₂, SiO₂, or Al₂O₃) particles and the polymer do not constitute the respective outer wall layers, but that the inorganic particles are evenly dispersed in the polymer matrix.

The present disclosure is not limited to the example described above, but can be manufactured in a variety of different forms. Those skilled in the art to which the present disclosure pertains will understand that other specific forms can be implemented without changing the technical spirit or essential features of the present disclosure. Therefore, preferred embodiments of the present disclosure have been described for illustrative purposes and should not be construed as being restrictive.

### EXPLANATION OF REFERENCE NUMERALS

1: Liquid non-flammable material (core)
2: Polymer-based organic-inorganic composite outer wall containing inorganic nanoparticles (first shell layer)
3: Polymeric material-based outer wall (second shell layer)

### INDUSTRIAL APPLICABILITY

In a fire-extinguishing microcapsule according to the present disclosure, provided is an outer wall (first shell) made of an organic polymer and an inorganic material, the outer wall surrounding a liquid non-flammable fire-extinguishing agent serving as a core for encapsulation. Therefore, a fire-extinguishing microcapsule capable of rapidly reacting to external temperature rise and adjusting the operating temperature range is implementable.

1. A fire-extinguishing microcapsule comprising:
a core comprising a non-flammable material;
a first shell layer covering the core, the first shell layer comprising an inorganic nanoparticle and a water-soluble polymer; and
a second shell layer covering the first shell layer, the second shell layer comprising a polymer.

2. The microcapsule of claim 1, wherein the non-flammable material is any one or a mixture of two or more selected from among methoxynonafluorobutane, dibromomethane, and methoxyheptafluoropropane.

3. The microcapsule of claim 1, wherein the inorganic nanoparticle comprises any one or a mixture of two or more selected from among titanium dioxide (TiO₂), silica (SiO₂), and alumina (Al₂O₃).

4. The microcapsule of claim 3, wherein a surface of the inorganic nanoparticle is modified with an acrylic group.

5. The microcapsule of claim 1, wherein the water-soluble polymer is any one or a mixture of two or more selected from the group consisting of gelatin, chitosan, chitin, pectin, locust bean gum, gellan gum, alginic acid, agar, carrageenan, collagen, hyaluronic acid, guar gum, ethylcellulose, methylcellulose, carboxymethylcellulose, and polyacrylic acid.

6. The microcapsule of claim 1, wherein the second shell layer comprises a urea-formaldehyde resin or a resorcinol-formaldehyde resin.

7. A method of preparing the microcapsule of claim 1, the method comprising:
(a) preparing an emulsion comprising a non-flammable material, an inorganic nanoparticle, and a water-soluble polymer;
(b) preparing a microcapsule comprising a core comprising the non-flammable material and a first shell layer comprising the inorganic nanoparticle and the water-soluble polymer by adding a pH adjuster to the emulsion for pH adjustment of the emulsion, adding a cross-linking agent, and stirring the resulting emersion; and
(c) forming a second shell layer comprising a polymer on the first shell layer of the microcapsule.

8. A fire-extinguishing composition comprising:
the microcapsule of claim 1; and
a binder.
